(19) United States
(12) Patent Application Publication
(10) Pub. No.: US 2016/0003225 A1
(43) Pub. Date: Jan. 7, 2016

(54) Method and modes for collecting and converting renewable energy sources and integrating them with traditional sources of energy to produce work in the most efficient cost effective manner possible

(71) Applicant: Brian P. Slee, Casselberry, FL (US)

(72) Inventor: Brian P. Slee, Casselberry, FL (US)

(73) Assignee: On-Point Power Systems Inc., Casselberry, FL (US)

(21) Appl. No.: 14/323,267

(22) Filed: Jul. 3, 2014

(51) Int. Cl. F03G 6/04; F03G 7/04

(52) U.S. Cl. CPC F03G 6/04; F03G 7/04

(57) ABSTRACT

The invention includes; a collector combined with a pressure vessel to collect energy from renewable resources to heat an exchange medium within the pressure vessel, a system to pre-compress the working gas, an injector to introduce the gas into the pressure vessel to absorb the energy collected, a diffuser to increase the surface area of the gas exposed to the exchange medium to increase exchange efficiencies, an accumulator to store sufficient amounts of the gas to initiate stable operation, a system of valves to ensure proper direction and flow of the working gas connected via pipe, tube, hose or conduit, an electronic or electrical system and software to manage the system through direct wiring, or wirelessly connected system sensors, electrical relays, and actuators to manage the process of energy collection and distribution, and components connected to the output via pipe, tube, hose or conduit.

### BACKGROUND OF THE INVENTION

Over the last few decades the environmental costs of burning fossil fuels has become a major issue that needs to be addressed and resolved before the damage to our ecosystem becomes irreversible and which may lead to catastrophic impacts on a global scale. Much work has been done in an attempt to produce a system capable of harnessing the large volume of energy freely available from renewable resources. While methods have been developed to do this, they suffer significant issues in their general application. Using solar energy as an example, we see that parabolic concentrators are very effective at collecting and focusing solar energy to produce a high quality source of heat that has been used to produce steam or run sterling motors to generate electricity. Unfortunately these systems require complex geometries and methods to keep them exactly aligned with the sun as it moves across the sky and also require significant amounts of technical expertise to maintain. Current flat plate collectors while easy to produce and capable of gathering the same amount of energy as the parabolic systems do not provide a high enough temperature to produce steam, which is the traditional product used to generate power, and so they have been relegated to the task of providing hot water. Finally direct energy conversion from solar to electrical power has been realized for some time but it suffers from very low efficiencies coupled with high costs due to the highly complex process to manufacture silicon based circuits. With very few exceptions, such as high grade geothermal and hydrodynamic sources, almost all other renewable sources of energy suffer from low quality and or intermittent availability. To alleviate these problems an invention is presented to overcome these issues and facilitate combining them into a single usable product to fulfill our energy requirements.

### SUMMARY OF THE INVENTION

The invention proposed is based on the physical law, that given a gas contained within a fixed volume, that pressure and temperature are directly related and will change in proportion to each other, i.e. For a fixed volume any increase in pressure will result in an increase in temperature directly proportional to the increase in pressure, and vice versa, any increase in temperature will result in an increase in pressure directly proportional to the increase in temperature.

The invention includes; A collector to collect energy from any freely available source of heat, such as solar, or low grade geothermal sources, combined with a pressure vessel to contain the energy from the source, which is filled with an exchange medium, preferably water, to exchange energy with a working gas, preferably air, a component or system to pre-compress the working gas, that may be powered by the heated working gas that is directed back to the compressor after gaining energy in the exchange process, in combination with, wind, hydrodynamic energy, a combustible fuel, or electrical source, an injector system to introduce the working gas, into the pressure vessel for the purpose of exchanging energy between the injected gas, and pressure vessels exchange medium to absorb the energy collected, a diffuser to increase the surface area of the working gas as it passes through the exchange medium to increase exchange efficiencies, an accumulator to store sufficient amounts of the working gas under pressure to initiate stable operation, a system of valves and manifold arrangements as necessary to ensure proper direction and flow of the working gas, connected via pipe, tube, hose or conduit, and an electronic or electrical control system and computer program to manage the system operation through direct wiring, or wirelessly connected internal and external system sensors, electrical relays, and actuators to manage the process of energy collection and distribution. During normal operation the system would use any available energy source to initially compress the working gas which is stored in an accumulator, when any source of heat is available to the collector the control system would operate a system of valves to port the compressed working gas into a pressure vessel containing an exchange medium imparting additional energy to the working gas which could then be directed to any number of components connected to the output which are capable of using the energy collected to produce work, such as an air conditioner, electrical generator, pump, etc . . . , additionally any retained heat could be routed through another heat exchanger placed in a hot water tank, or used as a pre-heater, to produce hot water. In the preferred embodiment the collector and pressure vessel(s) and injector(s) are combined in a flat panel arrangement mounted on a roof to collect solar energy or sunk into the ground to collect low grade geothermal energy or any other suitable location where heat may be absorbed or dispersed when used as a heat sink for cooling the working gas or other secondary gasses, fluids, elements or compounds and in any combination based on best use of resources available local to the system or logistically supplied by another person, party, company or utility. In a second preferred embodiment the collector would use a heat exchanger loop to deliver the energy collected to a pressure vessel mounted in a separate location for conversion and distribution. One example of the second preferred embodiment would be existing installations for solar powered hot water heaters which would only require the addition of an injector into the existing pressure vessel (hot water storage tank or boiler) and an output port to distribute the energy collected, and a system to manage and control the process and the possible addition of more collector panels to increase the yield. These are just a few examples and are in no way meant to limit the type of components or arrangements that may be used.

### BRIEF DESCRIPTION OF THE DRAWINGS

FIGS. 1 and 2—System Diagrams show major system components, gas flow, and control elements

FIG. 3—Logic Diagram with internal, external, and non-state variables and basic control algorithm

FIG. 4 Shows a pole mount installation of pressure vessels combined with the collector element that might be typically used to collect solar energy combined with ground mounted pressure vessels for heat exchange with a geothermal source.

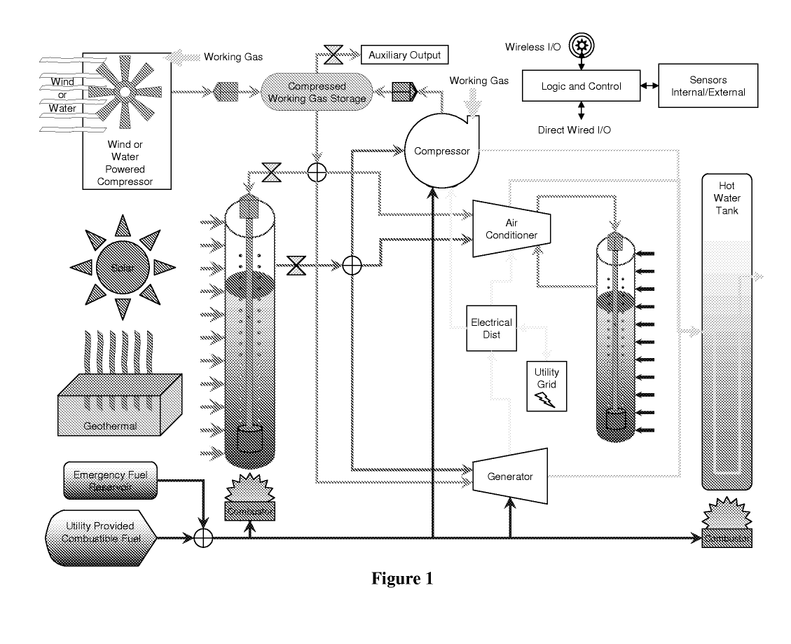

### DETAILED DESCRIPTION OF PREFERRED EMBODIMENT

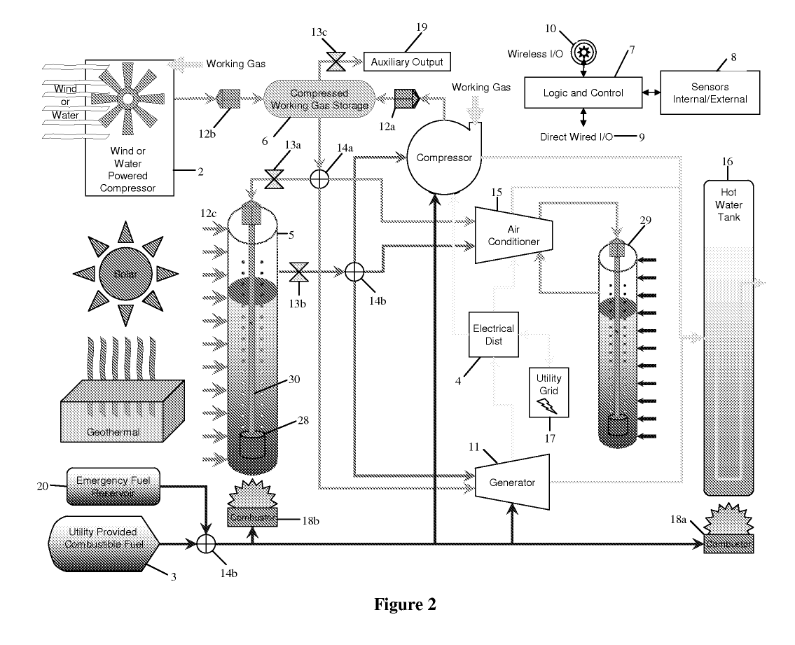

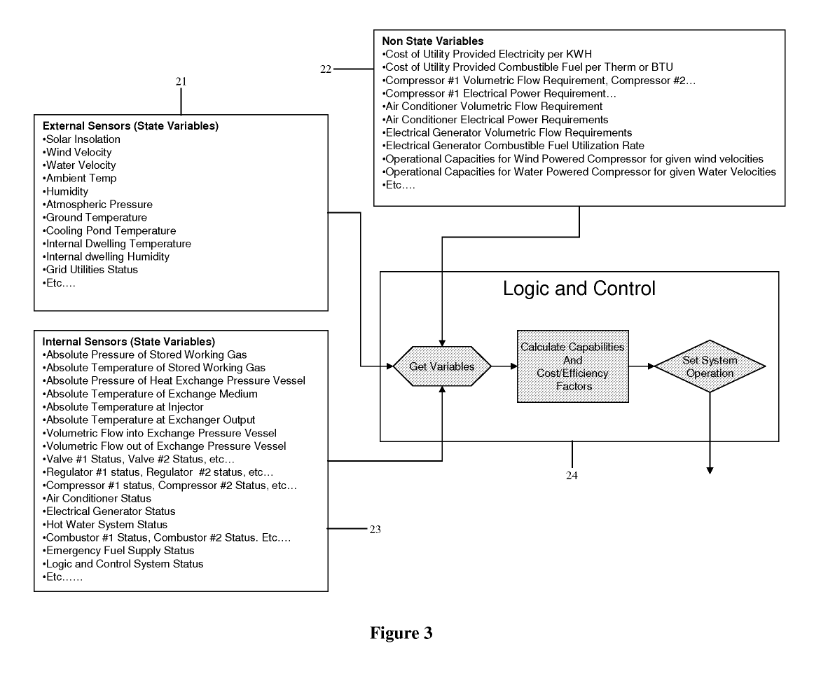

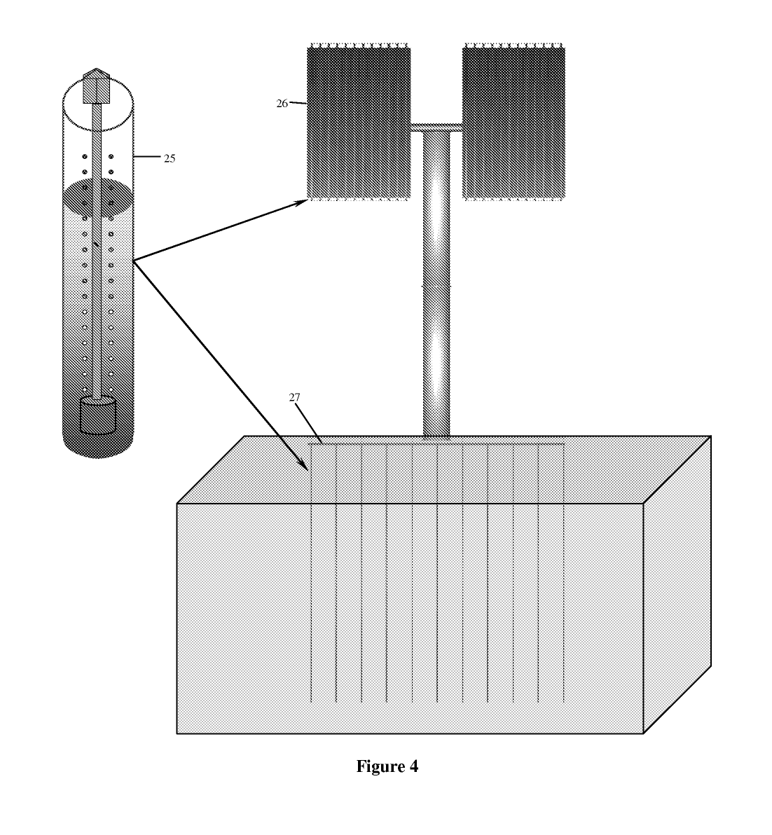

The following describes one of the preferred embodiments that would be used for a typical single family dwelling to provide or augment power needs and provide products in the forms of electrical power, air conditioning and hot water. The configuration presented, although specifically designed for a single family dwelling, contains the same components and operational characteristics for systems scaled up to meet multi family dwelling needs, industrial plant, and utility scale system requirements. Referring to FIGS. 2-4, in describing the system operation, it is assumed that there is enough wind velocity to compress the working gas in quantities to maintain stable system operations, it is a clear day with the sun shining and the solar collectors (26) have good exposure to the sun to heat the working gas, and that geothermal conditions support the ability of geothermal collectors (27) mounted underground or in a cooling pond or other body of water, to disburse heat and provide cooling to the working gas and or a second working gas to be used in an air conditioning system (11) to condition air within the dwelling. The process begins from a cold start condition meaning no power is applied, and the system has no pressurized working gas to start the energy collection and conversion process. Upon application of power to the system, the logic and control system (7) will run a self diagnostic on itself, followed by a system status check using sensors (8) that are wired directly (9) to, or wirelessly (7) connected to the logic and control system located internal (23) to the system's components. Following a successful systems check the logic and control system (7) will retrieve information on external environmental conditions (for discussion purposes external means external to the system and may include a number of sensors placed within the dwelling being serviced), via external sensors (21), that are wired directly (9) to, or wirelessly (7) connected to the logic and control system, and combined with non-state variables (22) calculate (24) the preferred mode of operation given current conditions. Following system diagnostics and calculation of the preferred mode of operation, a compressor (2) driven by wind in the case presented (or water where hydrodynamic sources are available), draws in the working gas, preferably ambient air, and compresses it, passing it through a check valve assembly (12b) to pre-charge the working gas storage tank (6) with the pressurized working gas. In the event that there is not enough wind velocity available to sustain operations, a separate compressor (1) capable of using the energized working gas, a combustible fuel, electricity or other readily available source of energy, will be used to compress the working gas. For a typical single family dwelling it is anticipated that the pressure in the working gas storage tank (6) will be approximately 10 atmospheres at full charge. When the compressed working gas storage tank (6) is sufficiently charged to initiate system operation the logic and control system (7) will initiate the collection and conversion process by opening the appropriate valves in the valve and manifold assembly (14a) to port the output from the compressed working gas storage tank (6) to the desired output port from the valve and manifold assembly (14a) which in the case presented would be through a regulator assembly (13a) and backflow prevention valve (12c) to the input of the injector system (30) and passed though a diffuser element (28) into the pressure vessels (5, 26) of the solar collector/exchanger assembly (25) which are mounted outdoors and exposed to solar radiation to absorb the energy to heat the exchange medium inside the pressure vessels (5, 26). As the working gas passes through the exchange medium it acquires additional energy and according to physical laws must either increase in pressure or attain equilibrium by increasing in volume. Rather than allowing the pressure in the pressure vessel (5) to increase the system ports the working gas out of the pressure vessels (5, 26) through a regulator (13b) allowing it to expand, carrying the additional energy with it out of the pressure vessel to whichever system component or components that the logic and control system (7) has selected to operate through a valve and manifold assembly (14b) to perform the work desired. For this discussion we will assume that there is ample energy available through wind, solar, and geothermal sources to provide all of the energy required to generate the desired products for the dwelling in the forms of electrical power and cooling air and some additional energy available in excess of current requirements of the dwelling. Having calculated that the available natural resources are sufficient to meet the dwellings needs and that there is excess energy available the logic and control system disconnects other power sources and (7) opens the valves of manifold and valve assembly (14b) to port the working gas to both the air conditioner (15), which uses a set of collector/exchanger tubes (27, 29) to cool a second working gas, and electrical generator and sets the electrical distribution system to feed the excess electrical energy to the utility power grid (17). After the majority of the energy is used by the system components any latent heat remaining may be ported through a hot water tank (16) or boiler for industrial scale systems or used in a heat exchanger to preheat a volume of water that would then be fed in to the hot water tank (16) or boiler to capture as much of the remaining energy as possible, or reversing the process the hot working gas may be ported through the hot water tank (16) or boiler first depending on the needs of dwelling, or industrial facility. Given different conditions the logic and control system can configure the system to use any combination available to fulfill the dwellings energy requirements and works continuously to monitor conditions internal and external to the system to ensure that the most efficient and cost effective mode is always used.

1. A combined collector and heat exchanger system, composed of a device or combination of devices, having single or multiple, inputs and outputs, which may include a collector capable of collecting heat energy from multiple sources, to include but not be limited to solar, geothermal, combustible fuel, or electrical source, combined with a pressure vessel filled with an exchange medium consisting of, preferably water, or any gas, fluid, element or compound suitable for said purpose, a method or device or combination of devices to control and maintain proper levels of the exchange medium within the pressure vessel, containing an internal heat exchanger system, composed of an injector to introduce a working gas to carry and distribute the energy collected, and an output which is able to deliver the working gas and energy imparted to the working gas to any device desired to produce work. For claim purposes the pressure vessel may also be any existing hot water heater or boiler system capable of safely maintaining the desired pressure conditions during operation of the system to reduce the number of components used or a separate pressure vessel specifically designed and used to collect, exchange, and transfer energy to the working fluid.

2. A method or system, consisting of a device or combination of devices, to compress a working gas preferably air, or any other gas, fluid, element or compound, capable of operating from multiple sources of available energy to include but not be limited to a working gas, preferably air, and/or wind, hydrodynamic, solar, geothermal, combustible fuel, or electrical source.

3. A method or system, consisting of a device or combination of devices, for injecting a pressurized working gas, consisting of air, or other gas or gas mixture, fluid, element, or compound directly into a pressure vessel to absorb energy from an exchange medium, and carry it from the output of a pressure vessel to the point of desired use.

4. A method or system, consisting of a device or combination of devices, to diffuse working gas as it is injected into an exchange medium in order to increase the surface area exposed to the exchange medium within the pressure vessel to increase exchange efficiencies.

5. A method or system, consisting of a device or combination of devices connected via pipe, tube, hose or conduit, or other method to direct the overall flow of a working gas, such as backflow prevention valves, and control the use of the working gas by directing it to the desired device to be powered, such as a valve and manifold assembly with a single input and multiple outputs or multiple inputs with a single output or multiple inputs to multiple outputs combined with any other flow control systems, that may be operated manually or remotely via direct wire or wireless connection, to port the desired input to the desired output which could be operated manually or remotely actuated as desired. The above examples are meant to be for explanatory purposes and in no way are meant to limit the available scope or options to control and direct the working gas.

6. A method or system, consisting of a device or combination of devices, to regulate the pressure and volume of a working gas into and out of a pressure vessel and at any other point where flow control and pressure regulation is desired and may be operated manually or remotely via direct wire or wireless connection.

7. A method or system, consisting of a device or combination of devices, to sense internal and external conditions and states of an energy collection and conversion system, its operating components, and external environment and which may be capable of connection to a logic and control component or system via either direct wire or wireless connection.

8. A method or system consisting of a device or combination of devices to provide program storage, logic operations and control functions for an energy collection and conversion system and any devices connected, and which is capable of using the data from internal and external sensors and any other non state variables to determine the most efficient and cost effective mode of operation.

9. A method or system, consisting of a device or combination of devices, to provide an emergency operating mode for an energy collection and management system capable of providing all needed electrical power and air conditioning during periods of outage of public utilities that may include sensors to detect the outage, a refillable emergency fuel reservoir, valves and controls and may be operated manually or remotely via direct wire or wireless connection, and normal logic and control method overrides for emergency operations.

10. A method or system, consisting of a device or combination of devices, to condition air for dwellings or provide refrigeration and heating for other enclosed spaces, capable of using multiple power sources to include a working gas produced by an energy collection and management system and/or electricity and/or other combination of energy sources and which may be capable of manual or remote control via connection to a logic and control component or system via either direct wire or wireless connection.

11. A method or system, consisting of a device or combination of devices, to generate electrical energy capable of using multiple power sources to include a working gas produced by an energy collection and management system and/or a combustible fuel or other combination of energy sources and which may be capable of manual or remote control via connection to a logic and control component or system via either direct wire or wireless connection.

12. A method or system, consisting of a device or combination of devices, to generate compressed air or other gas mixture, fluid, element or compound capable of using multiple power sources to include a working gas produced by an energy collection and management system and/or a combustible fuel and/or electricity, or other combination of energy sources and which may be capable of manual or remote control via connection to a logic and control component or system via either direct wire or wireless connection.

13. A method or system, consisting of a device or combination of devices, to pump or move fluids, gases or other products through an enclosed pipe, tube or conduit from a source to a destination, capable of using multiple power sources to include a working gas produced by an energy collection and management system and/or electricity and/or other combination of energy sources and which may be capable of manual or remote control via connection to a logic and control component or system via either direct wire or wireless connection.

14. Proprietary rights to develop and incorporate any additional components or systems or systems legally purchased and which are not specifically or legally barred from such use (with permission of the owner of rights to proprietary devices components, or systems, or devices, components), or disallow any component or system that may be connected to the system proposed to produce work or other usable product from the energy supplied by the system or in combination with other energy sources.

15. An auxiliary output connected to a compressed working gas storage tank to facilitate the use of common air tools and inflate objects using the pressurized working gas.
